(19) United States
(12) Patent Application Publication
(10) Pub. No.: US 2025/0340167 A1
(43) Pub. Date: Nov. 6, 2025

(54) VEHICLE SOUND SYSTEM

(71) Applicant: William E. Wilton, Orlando, FL (US)

(72) Inventor: William E. Wilton, Orlando, FL (US)

(21) Appl. No.: 19/267,444

(22) Filed: Jul. 11, 2025

Related U.S. Application Data
(63) Continuation-in-part of application No. 18/517,505, filed on Nov. 22, 2023.

(51) Int. Cl. B60Q 5/00; G10K 15/04; H04R 1/02

(52) U.S. Cl. CPC B60Q 5/005; G10K 15/04; H04R 1/025; H04R 2499/13

(57) ABSTRACT

A vehicle sound system includes a first speaker of a speaker assembly, the speaker assembly mounted to an external body or external frame of the vehicle; a sound module wirelessly or directly electrically connected to the first speaker, the sound module comprising: one or more processors, and memory; wherein upon the vehicle being placed in reverse, a reverse light power wire of the vehicle powers up the one or more processors causing modulated sound to be played through the speaker.

### RELATED APPLICATIONS

This application is a continuation-in-part of, and claims priority to, pending U.S. application Ser. No. 18/517,505 titled VEHICLE SOUND SYSTEM filed on Nov. 22, 2023 and the parent application is fully incorporated by reference for all it teaches and discloses.

### BACKGROUND OF THE INVENTION

Electric vehicles are the way of the future and one unexpected problem associated with electric vehicles is the lack of noise. The problem of lack of noise is not only associated with electric vehicles but quiet vehicles in general suffer from the same problem. Each year numerous avoidable accidents happen because of the lack of noise of quiet vehicles. Accidents involving people, animals, and other vehicles are preventable. The invention presented herein provides unique advantages and novelty related to quiet vehicles.

### SUMMARY OF THE INVENTION

A vehicle sound system includes a speaker of a speaker assembly, the speaker assembly mounted to an external body or external frame of the vehicle; a sound module wirelessly or directly electrically connected to the first speaker, the sound module comprising: one or more processors, and memory; wherein upon the vehicle being placed in reverse, a reverse light power wire of the vehicle powers up the one or more processors causing modulated sound to be played through the speaker

The vehicle sound system may further include smart phone application software running on a smart phone that interacts with the processor and memory of the sound module.

The vehicle sound system may further include a kinetic generator attached to the speaker assembly, the kinetic generator used to charge a battery of the power source as the vehicle moves.

The vehicle sound system may further include an echo chamber that acoustically interacts with the first speaker and a second speaker of the speaker assembly.

The vehicle sound system may include pre-recorded sounds that can be selected through the smart phone application and loaded into the memory and played upon the movement of the vehicle or the movement of the vehicle accelerator.

The vehicle sound system may further include a vehicle computer, of the vehicle, interacting with the sound module such that sounds from inside of the vehicle can be played in real-time through the first speaker.

The vehicle sound system may further include a smart car seat, the smart car seat including a microprocessor, memory, a temperature module, a communication module, a car seat speaker, a weight sensor, a microphone and a power source; wherein the first speaker plays predetermined sounds or phrases when a temperature inside of the vehicle detects a dangerous temperature condition for a child that is determined by the weight sensor to be in the car seat.

The vehicle sound system may include a motion sensor attached to speaker assembly and electrically connected to the sound processor such that forward motion or reverse motion of the vehicle is detected by the sound processor and predetermined sounds are played through the first speaker as a result of the forward motion or the reverse motion.

The vehicle sound system may include a wireless OBDII module that wirelessly interacts with the sound module.

The vehicle sound system may include a camera attached to the vehicle and upon detection of a moving object, animal, or person, through the camera, playing predetermined sounds through the first speaker.

The vehicle sound system may include a faux exhaust pipe.

The vehicle sound system may include a speaker assembly in the form of a faux exhaust pipe attached to a hybrid vehicle or an all electric vehicle.

The vehicle sound system may include an alarm system of the vehicle playing sound through a faux exhaust pipe.

The vehicle sound system may include playing an animal deterring sound through a faux exhaust speaker upon detection of an animal near or approaching the vehicle.

The vehicle sound system may include echo settings and effects of a first speaker and a second speaker, located within an echo chamber, being configurable through smart phone application software.

The vehicle sound system may include smart phone application software connected to a cloud data service for storing settings, storing sounds, and downloading pre-recorded sounds.

The vehicle sound system may include an intercom system that may be activated from a button within the vehicle enabling one or more microphones within the vehicle to direct spoken sounds through a faux exhaust pipe of the vehicle.

The vehicle sound system may include speaking through a microphone of a smart phone and playing the spoken words through a faux exhaust pipe of the vehicle.

The vehicle sound system may include smart phone application software that interacts simultaneously with a car seat and a sound module of a faux exhaust pipe allowing spoken sounds through a microphone of the smart phone to be spoken through the car seat and the faux exhaust pipe at the same time.

In another embodiment, the vehicle sound system may be powered and/or triggered by a reverse light of a vehicle. When a vehicle is placed in reverse, a reverse power light wire is sent power to turn on reverse lights in the back of a vehicle. The power for the vehicle sound system uses the reverse light wire to power an electronic circuit of the vehicle sound system and the same power wire triggers the vehicle sound system to broadcast an audible noise to warn of the vehicles intent to move in a reverse direction. The sound may be broadcast as a direct result of power being sent to the reverse light wire of a vehicle. The electronic circuit may be programmable by direct wired connection or may be programmed through bluetooth, wifi, or NFC. The reverse light power wire may trigger the preprogrammed sound to be played as a result of the electronic circuit of the vehicle sound system receiving power.

In other embodiments of the invention, features and advantages of the previously mentioned embodiments are combined to form additional embodiments as shown and described in relation to the detailed description of the invention.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a side view of a vehicle sound system in accordance with an embodiment of the invention;

FIG. 2 shows a flow diagram of a vehicle sound system in accordance with an embodiment of the invention;

FIG. 3 shows a graphical representation of a vehicle sound system in accordance with an embodiment of the invention;

FIG. 4 shows a flow diagram of a vehicle sound system in accordance with an embodiment of the invention;

FIG. 5 shows a flow diagram of a vehicle sound system in accordance with an embodiment of the invention; and

FIG. 6 shows smart phone application settings in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, but is merely representative of certain examples of presently contemplated embodiments in accordance with the invention. The presently described embodiments will be best understood by reference to the drawings.

All or part of the present invention may be embodied as a system, method, and/or computer program product. The computer program product may include a computer readable storage medium (or media) having computer readable program instructions thereon for causing a processor to carry out aspects of the present invention. For example, the computer program product may include firmware programmed on a microcontroller.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a chemical memory storage device, a quantum state storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming languages such as Smalltalk, C++ or the like, and conventional procedural programming languages such as the “C” programming language or similar programming languages. Computer program code for implementing the invention may also be written in a low-level programming language such as assembly language.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

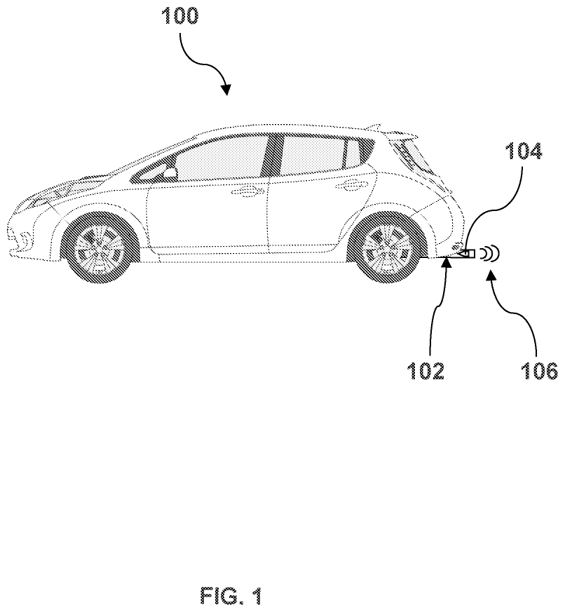

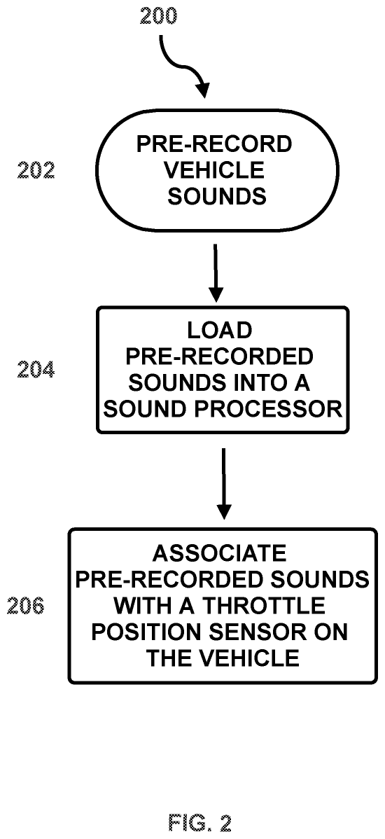

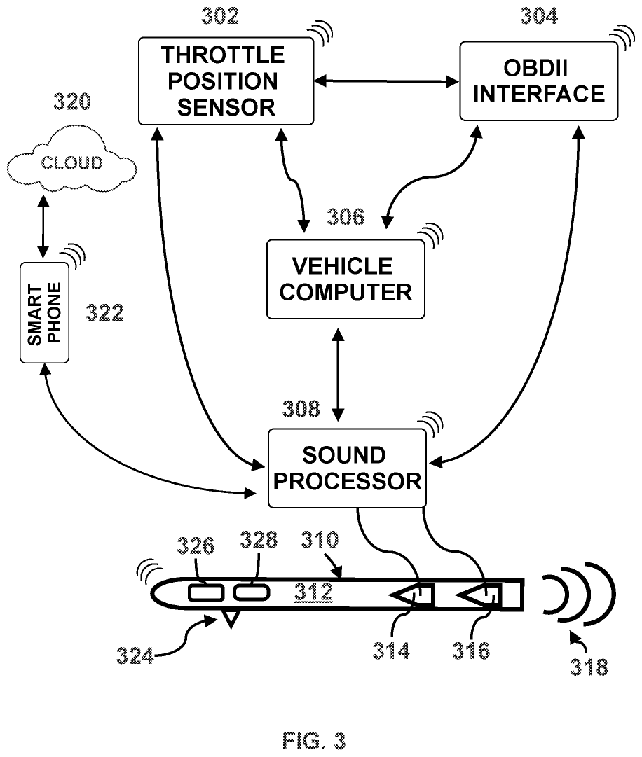

FIG. 1 shows a side view of a vehicle 100 in accordance with an embodiment of the invention. Vehicle 100 may be an all electric vehicle, a hybrid vehicle, a quiet vehicle, or a traditional motorized vehicle. Vehicle 100 may include a speaker assembly 102. One or more speaker systems 102 may be used in tandem similar to a dual exhaust system of a traditional vehicle. The speaker assembly 102 may be mounted to an external frame, external surface, or external body of vehicle 100. Speaker assembly 102 may include one or more speakers for creating sounds 106. In some embodiments, up to eight speakers may be placed in a single speaker assembly. The multiple speakers may form a dynamic array of speakers able to create dynamically modulated sound waves with the ability to modulate sound propagation direction, intensity, and frequency through independent output channels. Each of the speakers may be independently powered for creating dynamic sounds and directionality of the sounds. Sounds 106 may be triggered upon a movement of vehicle 100. Various sound types may be triggered and transmitted as sounds 106 as described in relation to FIGS. 2-6. Vehicle 100 although shown as a car, may be any type of motorized vehicle such as but not limited to: a train, plane, drone, bicycle, motorcycle, boat, etc. where the vehicle sound system of the present invention may be advantageous or desirable. Speaker assembly 102 may be mounted in a visible location as shown or may be mounted in a non-visible location such as under vehicle 100 or in a non-visible body cavity. Speaker assembly 102 may be in the form of a faux exhaust pipe and produce sounds 106 of a vehicle engine, vehicle motion, and other sounds as described in relation to FIGS. 2-6. Sounds 106 may include predetermined and preconfigured sounds produced by or played through a sound processor 308 (shown in FIG. 3). Sound processor 308 may be housed locally in, on, or near speaker assembly 102 or be part of a vehicle computer or vehicle sound system. Speaker assembly 102 may be positioned in a vehicle front, side, rear, top or combinations thereof. Sounds 106 may be directed in a desired direction by a physical mounting of one or more speaker assemblies 102, by positions of one or more speakers attached to the speaker assembly 102, by one or more apertures in the speaker assembly 102 and/or inside dimensions of the speaker assembly 102 forming an echo chamber, or by timing of sound signals sent to the one or more speakers of speaker assembly 102. Multiple speaker assemblies may be used in a multiple faux exhaust system such as in a dual exhaust vehicle.

In another embodiment, Vehicle 100 contains a reverse light wire for providing power to a backup light of vehicle 100. As vehicle 100 is placed in reverse, the reverse light wire is energized and may trigger sound to be played through one or more speakers of speaker assembly 102 by energizing sound processor 308 within speaker assembly 102. Speaker assembly 102 and sound processor 308 may have no other power except for the power provided by the reverse light wire of vehicle 100.

FIG. 2 shows a flow diagram 200 of a vehicle sound system in accordance with an embodiment of the invention. At step 202 vehicle sounds are pre-recorded. A library of vehicle sounds may be recorded and kept in a cloud data service or placed in a downloadable library or on a memory device. Pre-recorded vehicle sounds may be selectable based on a make, model, and year of a vehicle. At step 204 a user is able to select a vehicle sound and load the vehicle sound into a local sound processor of a user vehicle. The selection may be by a user interface on a smart phone or by a vehicle computer. For instance, a user of an all electric vehicle wants their vehicle to sound like an expensive sports car and selects a specific sports car sound to load into their local sound processor. After the sound is loaded, the sound is associated 206 with a throttle position sensor of the vehicle or with movement of the vehicle to trigger the selected sound to be played through one or more faux exhaust pipes of the electric vehicle. Movement of the vehicle may be detected by a motion sensor attached to speaker assembly, a faux exhaust system, or a factory installed vehicle motion sensor. An OBDII wireless adapter may be used to interface vehicle sensors, computers, and/or controls with a smart phone and/or local sound processor associated with the vehicle sound system of the present invention.

FIG. 3 shows a graphical representation 300 of a vehicle sound system in accordance with an embodiment of the invention. Speaker assembly 310 is shown with a kinetic generator 326 inside of an echo chamber 312 of the speaker assembly 310. Speaker assembly 310 may additionally include a battery 328 which may be charged by kinetic generator 326 and/or by a direct power connection to a vehicle to which the speaker assembly 310 is attached. Kinetic generator 326 may be used as a stand-alone device to charge battery 328 or in combination with a wired power connection to a vehicle to which the speaker assembly 310 is attached. Kinetic generator 326 may comprise a magnet that moves a magnetic field created by the magnet past a coil to produce a voltage and current in response to movement of a vehicle that the speaker assembly is attached to. The generated power may be used for charging and operating a sound processor 308 attached to the speaker assembly. Sound processor 308 may be physically located within speaker assembly 310 or may be physically located outside of speaker assembly 310. In some embodiments, sound processor 308 may be integrated into a vehicle sound system or vehicle computer system 306. Sound processor 308 may include a power source, one or more wireless communication modules, one or more processors, memory, a wired or wireless user interface, one or more sound output channels connected to a first speaker 314 and a second speaker 316. Sound processor 308 may be wirelessly connected or directly connected by wires to a smart phone 322, a vehicle computer 306, a vehicle sound system, a cloud based data service 320, a throttle position sensor 302 and/or an OBDII interface 304. Sound processor 308 may include a plurality of output channels and send timed sound signals to a plurality of speakers, sound transducers, and/or acoustic transducers to create one or more sounds echos, sound patterns, animal avoidance sounds, music signals, and/or directional sound patterns. For instance, a vehicle camera may detect a deer approaching a passenger side of the vehicle and a vehicle computer may then determine a position, direction and angle to transmit avoidance sounds. The computer 306 may then transmit to the sound processor 308 the position, direction, and angle to transmit the avoidance sounds. The sound processor then sends sound signals to one or more speakers of the speaker assembly to optimize the sound propagation trajectory for optimal results. Optimal results may be achieved in part by: sound timing, selection of a number of speakers to use, directional sound propagation based on speaker selection, frequency ranges used, and sound intensity. The optimal sound output settings may be automatically determined base on the type of the animal detected and the speed of the vehicle. In another example, a child is spotted by a vehicle camera and similar optimized sound output settings may be automatically determined to keep the child safe. In another example, a person is approaching a vehicle and a security system of the vehicle is set to speak through a faux exhaust pipe to the person approaching the vehicle and similar optimized sound output settings may be automatically determined to communicate with the person approaching the vehicle. In another example, a smart phone user is alerted when a vehicle security notification is generated and sound settings are optimized allowing the user to speak through their microphone on their smart phone and through the faux exhaust pipe on their vehicle and/or through a child car seat in the vehicle. If a dangerous temperature condition arises within the car and a child is determined to be in the car, automatic help notification sounds may be played through the faux exhaust speaker system and notifications may be sent out to one or more smart phone users. A motion sensor 324 may be attached to the speaker assembly 310 for detecting movement of a vehicle. The motion sensor may be a camera motion sensor, a laser motion sensor, a gyroscopic motion sensor, a GPS motion sensor, a kinetic energy generator may be used to detect vehicle motion, or a combination thereof. A vehicle moving in reverse motion detection may be set to automatically broadcast predetermined sounds and the predetermined sounds may be automatically triggered upon the detection of the reverse motion or forward motion of the vehicle.

In another embodiment shown in FIG. 3, speaker assembly 310 may not contain a generator 326 or battery 328 but may be entirely powered exclusively by a reverse light power wire of a vehicle to which the speaker assembly 310 is attached. The speaker assembly 310 may be automatically powered up and sound triggered as a vehicle is placed into reverse and the reverse light power wire is energized. The sound processor 308 may be programmed, preprogrammed, or reprogrammed to emit specific sound while the vehicle is in reverse with the sound processor 308 being powered up. The programming may be wireless programming such as bluetooth, wifi, or NFC.

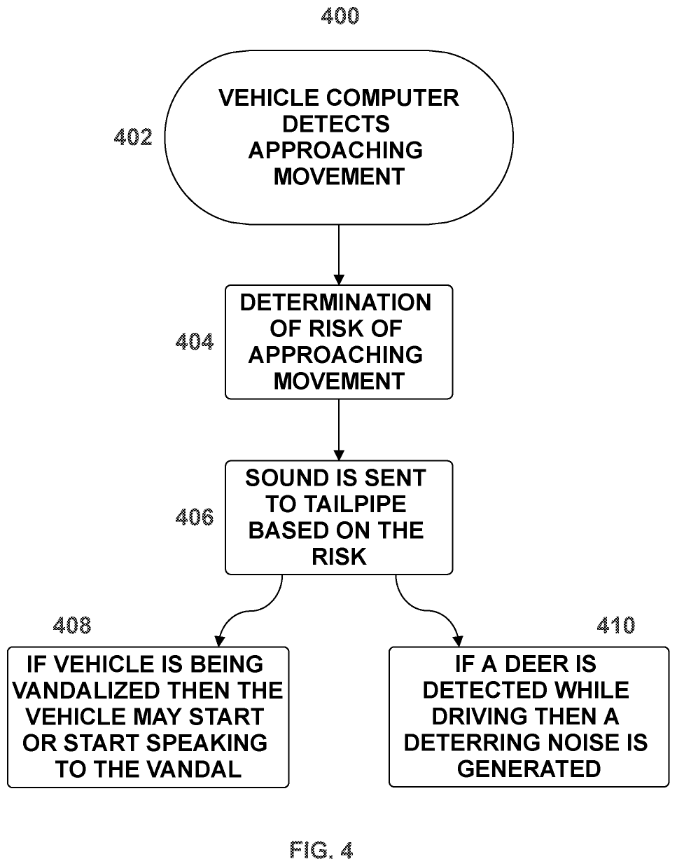

FIG. 4 shows a flow diagram 400 of a vehicle sound system in accordance with an embodiment of the invention. At step 402, a vehicle detects movement outside of the vehicle approaching the vehicle. At step 404, risk of the movement is assessed. This may be a determination of an impact or a potential impact. For instance, a driver is pulled over changing his flat tire on the side of a highway and another vehicle starts to slide into the vehicle with the flat tire. As an impact is determined, the vehicle starts reporting 404 the impact through the faux exhaust speakers and the driver changing his tire is able to roll out of the way just in time before impact. In another example, a vandal is warned off by the sound 408. In another example, a deer is deterred by the sound 410.

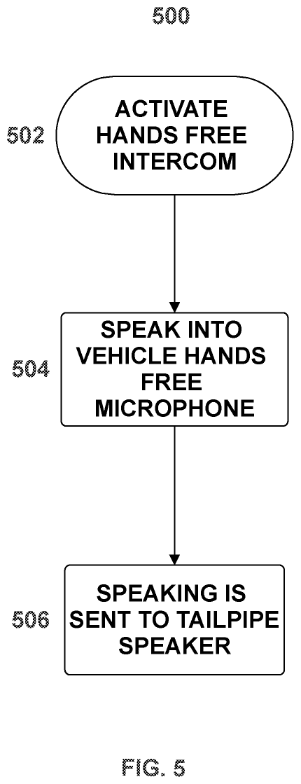

FIG. 5 shows a flow diagram 500 of a vehicle sound system in accordance with an embodiment of the invention. At step 502, a driver wants to speak through his faux exhaust speakers and pushes a button inside of the vehicle to activate hands free intercom or uses “hey siri” to activate an intercom from inside of the vehicle to the faux exhaust speakers 502. At step 502 the driver speaks into one or more of the vehicle microphones 504. At step 506, the voice of the driver is transmitted through the faux exhaust speakers. The volume and direction may be controlled by the driver and optimized output signals may be used to broadcast the drivers voice in a controlled direction, intensity, and modulation.

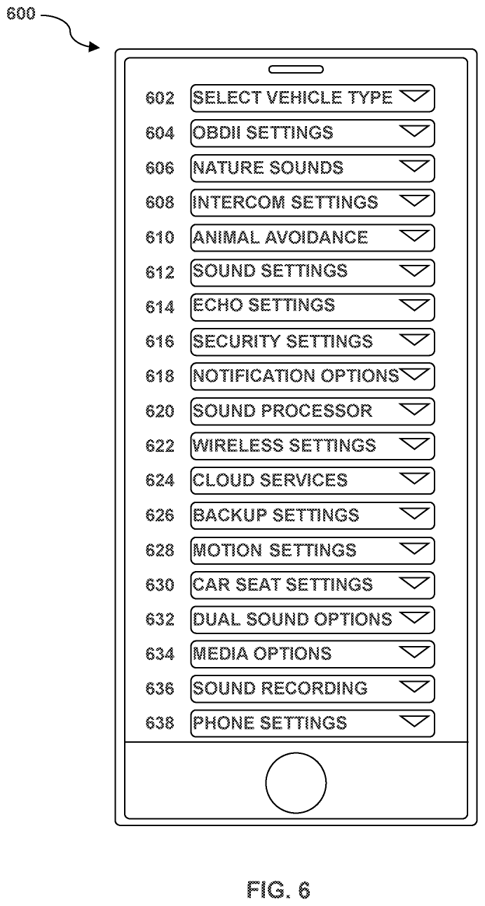

FIG. 6 shows smart phone application settings 600 in accordance with an embodiment of the invention. At 602 a type of vehicle is selected to which the speaker assembly is attached. Pre-defined settings may then be loaded that allow communication with a computer of the vehicle and the sound processor and access to motion sensors and cameras associated with the vehicle. At 604, OBDII settings may include wireless communication settings that allow an OBDII module to wirelessly connect to both a smart phone and the sound processor. At step 606, a library of nature sounds may be pre-selected to be played through the speaker assembly. Nature sounds may include avoidance sounds and/or ringtones to be played through the faux exhaust system. At step 608, intercom settings may include logging into a Google, Amazon, or Apple account and enabling a digital assistant to help in speaking hands free through the intercom system. The intercom settings may allow a microphone of a smart phone, smart device, or a vehicle to be used to speak through the faux exhaust system. At step 10, animal avoidance settings may include on/off settings, how aggressively to monitor and respond to animals (do you want to keep dogs/cats/birds/squirrels from approaching a parked car), settings for animals while the vehicle is moving and settings for animals while the vehicle is not moving. At step 612, sound settings may include selecting a number of faux exhaust systems installed on your vehicle, settings for playing a radio station through your exhaust system, settings for playing music through your smart phone through your exhaust system, and settings for speaker phone and phone ringing through your faux exhaust system. At step 614, echo settings related to reverberation as a vehicle is revved up, idling of an all electric vehicle, sound intensity related to echo, and echo direction related to speaker selection. At step 616, vehicle security settings are integrated with external sound settings, informing a person if they are too close to a vehicle, vehicle alarm sounding through the faux exhaust pipe(s), audio feedback on facial recognition entry to a vehicle, audio feedback of interaction on an approved smart phone, security authentication through a smart phone based on audio signals received through the faux exhaust speakers and received into a smart phone near the vehicle as the audio authentication is sent through the vehicle faux exhaust system and received into a smart phone microphone as a first or second security authentication factor. At step 618, notification options related to security detections reported to a smart phone, animals near the vehicle, and dangers to an infant or child in the vehicle related to extreme or dangerous temperatures of hot or cold inside of the vehicle when an infant or child is determined to be in the vehicle. At step 620, sound processor settings are configured relating to wireless connections, software updates for the sound processor, power settings, battery settings, etc. At step 622, wireless settings include pairing setting for smart phones and vehicle computers and wifi setup. At step 624, cloud services are configured allowing sound uploads/downloads related to sounds played through sound processor, subscription services related to security, vehicle data services, remote voice through muffler service, and remote tailgating music and sporting services through muffler. At step 626, a setting data backup service can be configured. The backup service may be a cloud service or may use a smart phone memory to backup settings on memory in the smart phone device or with a service connected to the smart phone. At step 628, menu motions settings related to preconfigured sounds for backing up, moving forward, idling, revving (pushing on the accelerator) or software revving (revving while not moving). At step 630, menu car seat setting related to detecting and communication with a child car seat. At step 632, menu sound options related to multiple faux exhaust systems and multiple speaker systems that can play multiple sounds and combinations of sounds for dynamic sound effects. At step 634, media menu options including radio, sporting, and audio books to be played through the exhaust system. At step 636, sound recording menu options for recording sounds to be added to a user created library of sounds. At step 638, phone menu settings are presented that allow a phone to be authorized or paired to be connected to the vehicle sound system.

The systems and methods disclosed herein may be embodied in other specific forms without departing from their spirit or essential characteristics. The described embodiments are to be considered in all respects only as illustrative and not restrictive. All changes which come within the meaning and range of equivalency of the inventive concepts shown and described are to be embraced within their scope.

1. A vehicle sound system mounted to an external body or external frame of a vehicle comprising:
a speaker assembly, the speaker assembly mounted to the external body or external frame of the vehicle;
a sound module located within the speaker assembly and directly electrically connected to a speaker of the speaker assembly, the sound module comprising: one or more processors, and memory;
wherein upon the vehicle being placed in reverse, a reverse light power wire of the vehicle powers up the one or more processors causing modulated sound to be played through the speaker.

2. The vehicle sound system of claim 1, wherein the memory can be programmed and reprogrammed to play predetermined sounds when the reverse light power wire is energized.

3. The vehicle sound system of claim 2, wherein the memory is wirelessly programmable while the vehicle is in reverse.
